(19) United States
(12) Patent Application Publication
(10) Pub. No.: US 2021/0276654 A1
(43) Pub. Date: Sep. 9, 2021

(54) MEASURING DEVICE AND MEASURING METHOD FOR MEASURING BICYCLE PEDALING FREQUENCY

(71) Applicant: TEKTRO TECHNOLOGY CORPORATION, Changhua County (TW)

(72) Inventors: Tzu-Chang Wang, Changhua County (TW); Po-Hsien Huang, Changhua County (TW)

(21) Appl. No.: 17/156,999

(22) Filed: Jan. 25, 2021

(30) Foreign Application Priority Data
Mar. 6, 2020 (TW) 109107346

(51) Int. Cl. B62J 45/414; B62J 45/412; B62J 50/22

(52) U.S. Cl. CPC B62J 45/414; B62J 45/423; B62J 50/22; B62J 45/412

(57) ABSTRACT

A measuring device includes an acceleration sensing module, a signal acquisition module, and a pedaling frequency. The acceleration sensing module is configured to produce an acceleration signal according to an acceleration of a bicycle. The acceleration signal is associated with an acceleration waveform information. The signal acquisition module is electrically connected to the acceleration sensing module. The signal acquisition module acquires the acceleration waveform information from the acceleration signal according to a predetermined parameter. The pedaling frequency calculation module is electrically connected to the signal acquisition module. The pedaling frequency calculation module calculates a pedaling frequency data according to the acceleration waveform information. In addition, a measuring method is also provided.

### CROSS-REFERENCE TO RELATED APPLICATIONS

This non-provisional application claims priority under 35 U.S.C. § 119(a) on patent application No(s). 109107346 filed in Taiwan, R.O.C. on Mar. 6, 2020, the entire contents of which are hereby incorporated by reference.

### TECHNICAL FIELD

The disclosure relates to a measuring device and a method for measuring bicycle pedaling frequency, more particularly to a measuring device and a measuring method that can be applied to measure pedaling frequency through analysis of acceleration waveform.

### BACKGROUND

Road bike racing is one of the most popular sports, wind, hills, and surface of the road are constantly changing, thus the cyclist is required to accordingly update the training programs. Maintaining an optimal pedaling frequency is one of the skills not only to improve the cycling performance but also to reduce the risk of foot injury. Thus, pedaling frequency training has always been an important course of training. For this matter, how to collect and analyze the pedaling frequency during training has become an important topic in this field.

### SUMMARY

The disclosure provides a measuring device and a measuring method that can be applied to analyze the acceleration waveform so as to timely obtain an accurate pedaling frequency of cycling.

One embodiment of the disclosure provides a measuring device. The measuring device includes an acceleration sensing module, a signal acquisition module, and a pedaling frequency. The acceleration sensing module is configured to produce an acceleration signal according to an acceleration of a bicycle. The acceleration signal is associated with an acceleration waveform information. The signal acquisition module is electrically connected to the acceleration sensing module. The signal acquisition module acquires the acceleration waveform information from the acceleration signal according to a predetermined parameter. The pedaling frequency calculation module is electrically connected to the signal acquisition module. The pedaling frequency calculation module calculates a pedaling frequency data according to the acceleration waveform information.

Another embodiment of the disclosure provides a measuring method. The measuring method includes producing an acceleration signal associated with an acceleration waveform information according to an acceleration of a bicycle by an acceleration sensing module, acquiring the acceleration waveform information from the acceleration signal according to a predetermined parameter by a signal acquisition module electrically connected to the acceleration sensing module, and calculating a pedaling frequency data of the bicycle according to the acceleration waveform information by a pedaling frequency calculation module electrically connected to the signal acquisition module.

Still another embodiment of the disclosure a measuring device. The measuring device includes a bicycle component, a control unit, a power supply unit, and an acceleration sensor. The bicycle component is configured to be mounted on a part of a bicycle that is not movable in a circular motion. The control unit is disposed in the bicycle component. The power supply unit is disposed in the bicycle component and electrically connected to the control unit for providing electricity to the control unit. The acceleration sensor is disposed in the bicycle component and electrically connected to the control unit. The acceleration sensor is configured to produce and provide an acceleration signal of the bicycle to the control unit to allow the control unit to calculate and produce a pedaling frequency signal according to the acceleration signal.

As the measuring devices and measuring method discussed in the above embodiments, the acceleration waveform information obtained by analyzing the acceleration of the bicycle can be used to accurately calculate the pedaling frequency data. As such, the cyclist can timely obtain an accurate pedaling frequency of cycling.

### BRIEF DESCRIPTION OF THE DRAWINGS

The present disclosure will become better understood from the detailed description given herein below and the accompanying drawings which are given by way of illustration only and thus are not intending to limit the present disclosure and wherein:

FIG. 1 shows a block diagram of a measuring device according to one embodiment of the disclosure;

FIG. 2 shows an exemplary acceleration waveform measured by the measuring device according to one embodiment of the disclosure;

FIG. 3 shows another exemplary acceleration waveform measured by the measuring device according to another embodiment of the disclosure;

FIG. 4A is a speed-time graph chart of a wheel measured by the measuring device according to one embodiment of the disclosure;

FIG. 4B shows a forward acceleration waveform that contains the information of FIG. 3;

FIG. 5 shows a block diagram of a measuring device according to another embodiment of the disclosure;

FIG. 6 is a flow chart of a measuring method according to one embodiment of the disclosure;

FIG. 7 is a flow chart of a measuring method according to another embodiment of the disclosure;

FIG. 8A shows a block diagram of a measuring device according to one embodiment of the disclosure;

FIG. 8B shows a block diagram of a measuring device according to one embodiment of the disclosure;

FIG. 9 shows a schematic view of a bicycle according to one embodiment of the disclosure;

FIG. 10A is a block diagram of a measuring device according to one embodiment of the disclosure; and

FIG. 10B is a block diagram of a measuring device according to another embodiment of the disclosure.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

In addition, the terms used in the present disclosure, such as technical and scientific terms, have its own meanings and can be comprehended by those skilled in the art, unless the terms are additionally defined in the present disclosure. That is, the terms used in the following paragraphs should be read on the meaning commonly used in the related fields and will not be overly explained, unless the terms have a specific meaning in the present disclosure.

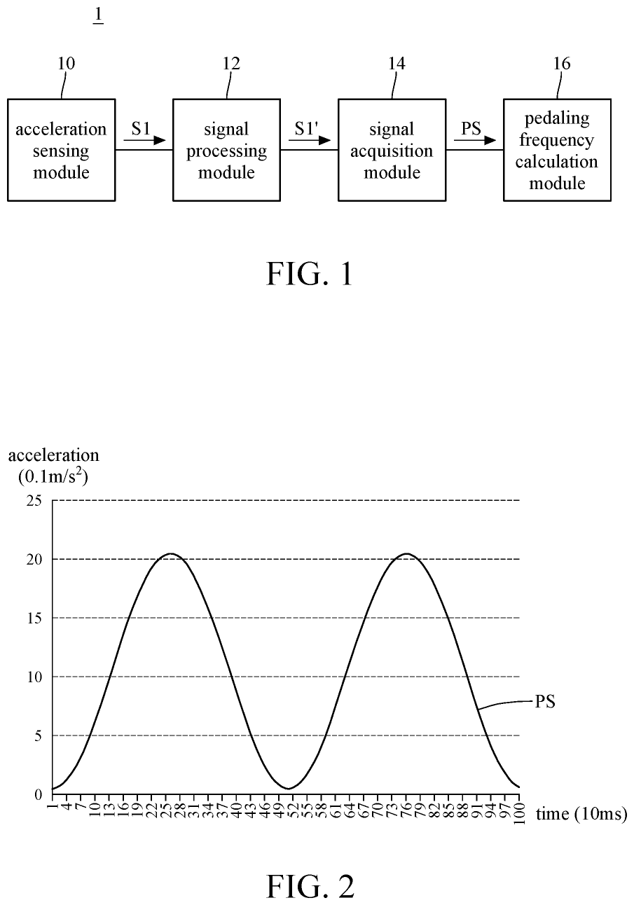

Referring to FIG. 1, there is shown a block diagram of a measuring device 1 for bicycle pedaling frequency according to one embodiment of the disclosure. As shown in FIG. 1, the measuring device 1 includes an acceleration sensing module 10, a signal processing module 12, a signal acquisition module 14, and a pedaling frequency calculation module 16. The acceleration sensing module 10 is electrically connected to the signal processing module 12, and the signal acquisition module 14 is electrically connected to the signal processing module 12 and the pedaling frequency calculation module 16.

The acceleration sensing module 10 is mounted on a bicycle (not shown). The acceleration sensing module 10 is configured to produce an acceleration signal S1 indicative of the acceleration of the bicycle. Specifically, the acceleration sensing module 10 can provide an acceleration signal S1 in response to the acceleration of the bicycle, where the acceleration signal S1 is associated with information of the acceleration waveform of the bicycle. The acceleration sensing module 10 then transmits the acceleration signal S1 to the signal processing module 12. In practice, the acceleration sensing module 10 can be implemented as an acceleration sensor of gravity (e.g., a G-sensor) or a Hall sensor, but the type of the acceleration sensing module 10 is exemplary and not intended to limit the disclosure.

The signal processing module 12 is able to perform a filtering step on the acceleration signal S1, including measurement error filtering and noise filtering. Specifically, the acceleration signal S1 from the acceleration sensing module 10 may contain a certain amount of measurement error or external noise. In order to prevent the measurement error or noise from affecting the analysis of the acceleration signal S1, the signal processing module 12 may be implemented as a noise filter to perform the filtering step to filter out the measurement error and the external noise. By doing so, a filtered acceleration signal S1′ for the later analysis is obtained.

The acceleration signal S1′ is transmitted to the signal acquisition module 14. The signal acquisition module 14 acquires an acceleration waveform from the acceleration signal S1′ according to one or more predetermined parameters. In detail, the acceleration signal S1′ includes an acceleration waveform information PS that is related to the pedaling, and the signal acquisition module 14 is able to acquire the acceleration waveform information PS from the acceleration signal S1′ according to one or more predetermined parameters. Then, the acceleration waveform information PS is transmitted to the pedaling frequency calculation module 16. Note that the signal processing module 12 is optional and is not intended to limit the disclosure. The measuring device of some other embodiments may not have the signal processing module 12; in such a case, the acceleration signal S1 is directly transmitted to the signal acquisition module 14.

In addition, the aforementioned predetermined parameters may include an acquisition frequency range, and the frequency of the acceleration waveform information falls within the acquisition frequency range. In practice, the signal acquisition module 14 may have a Band-Pass filter for filtering out unwanted frequency and remaining a specific range of frequency. The pedaling frequency generally falls within a range of 1 Hz to 3 Hz, thus the acquisition frequency range may be set to a range from 1 Hz to 3 Hz. As such, the signal acquisition module 14 can partially filter out the waveform of the acceleration signal S1′ so as to eliminate the frequencies outside the range of 1 Hz to 3 Hz. Note that the value of the acquisition frequency range can be modified as required and which is not intended to limit the disclosure.

In one embodiment that the acceleration sensing module 10 is a G-sensor, the acceleration sensing module 10 can be disposed on a non-rotatable part of the bicycle frame. In this arrangement, the acceleration sensing module 10 is able to obtain a forward acceleration signal in response to the acceleration of the bicycle frame, where the forward acceleration signal is employed as the acceleration signal S1. In more detail, in this embodiment, the acceleration of the bicycle frame is equivalent to the forward acceleration of the entire bicycle. The acceleration sensing module 10 (G-sensor) can detect the acceleration of the bicycle moving forwards so as to produce the forward acceleration signal that can be served as the acceleration signal S1.

Ideally, the non-rotatable part may be selected from a handlebar, a fork, a seat stay of the bicycle, or another portion of the bicycle that does not rotate while the bicycle is moving forwards, such a position ensures that the G-sensor can accurately obtain the value of the acceleration of the bicycle moving forwards. For the same reason, the signal processing module 12 (if exist), the signal acquisition module 14, the pedaling frequency calculation module 16, and other modules all can be integrally disposed on the non-rotatable part of the bicycle.

As the acceleration sensing module 10 receives the forward acceleration signal (being served as the acceleration signal S1), the acceleration signal S1 is then transmitted to the signal processing module 12, and the signal processing module 12 will filter out part of the acceleration signal S1 so as to turn it into the acceleration signal S1′. In detail, the signal processing module 12 is configured to remove the measurement error and/or noise existing in the acceleration signal S1, and the remaining is denoted as the acceleration signal S1′. Therefore, the acceleration signal S1′ is a forward acceleration signal that does not contain unwanted measurement error and noise.

Referring to FIG. 2, the acceleration waveform information PS shown in FIG. 2 is acquired from the acceleration signal S1′ by the signal acquisition module 14 according to one or more predetermined parameters. Specifically, in FIG. 2, the acceleration waveform information PS is obtained by the signal acquisition module 14 filtering out the frequencies of the acceleration signal S1′ that fall out of the range of 1 Hz to 3 Hz. Then, the signal acquisition module 14 transmits the acceleration waveform information PS to the pedaling frequency calculation module 16 for waveform reconstruction and pedaling frequency calculation. In FIG. 2, the two sine waves respectively represent a downstroke of the left pedal and a downstroke of the right pedal; that is, the two sine waves represent a stroke cycle of either the right or left pedal; in specific, the first wave crest, the first wave trough, the second wave crest, and the second wave trough of the sine waves are formed and respectively reflect that one of the left and right pedals has been pivoted about 90, 180, 270, and 360 degrees from the top position. In other words, the number of sine waves can represent the number of downstrokes; that is, two continuous sine waves mean two continuous downstrokes (e.g., one left downstroke and one right downstroke). As such, the number of the sine waves during a unit time period can be served as a pedaling frequency data by the pedaling frequency calculation module 16. In practice, the pedaling frequency calculation module 16 may be a processor, microprocessor, controller, or micro controller capable of calculating pedaling frequency and performing waveform reconstruction using imputation method.

Note that the acceleration sensing module of another embodiment can be implemented to include a hall sensor. In this case, the acceleration sensing module detects the wheel speed using the hall sensor, then obtain the forward acceleration from the wheel speed, and then obtain the pedaling frequency data according to the forward acceleration. The details will be provided in the following paragraphs.

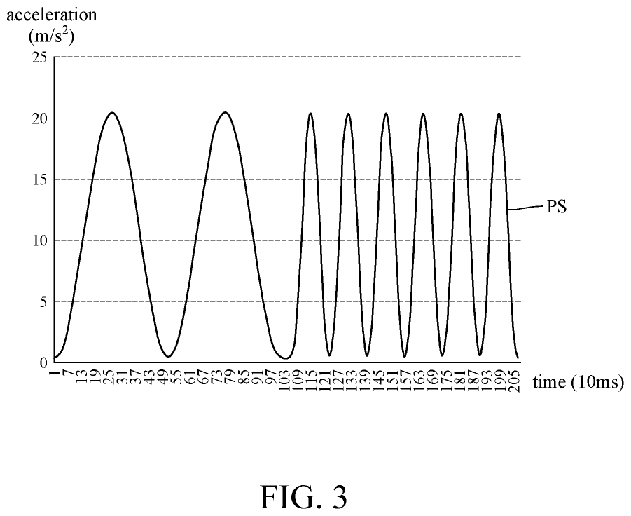

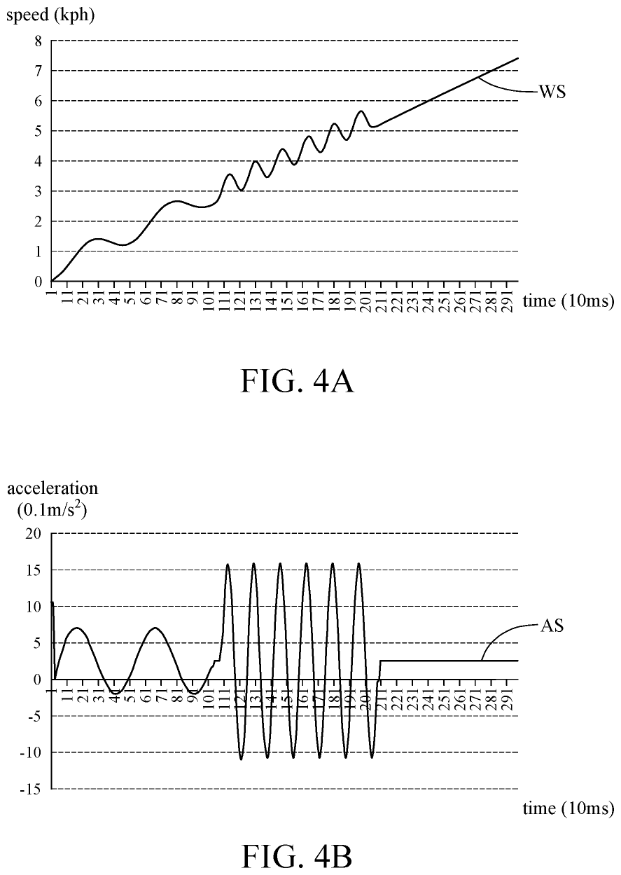

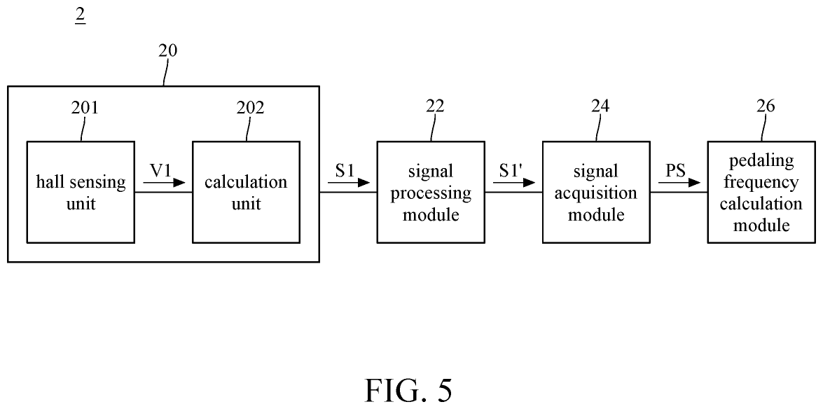

Referring to FIG. 3, the acceleration waveform information PS has multiple sine waves with different frequencies, meaning that the pedaling frequency varies during a unit time period. Further referring FIGS. 4A and 4B, FIG. 4A shows the wheel speed information related to the acceleration waveform information PS in FIG. 3, and FIG. 4B shows a forward acceleration signal derived from FIG. 4A. The details of FIGS. 3B-4B will be clear with reference to FIG. 5, where FIG. 5 shows a block diagram of a measuring device 2 according to another embodiment of the disclosure.

As shown in FIG. 5, the measuring device 2 includes an acceleration sensing module 20, a signal processing module 22, a signal acquisition module 24, and a pedaling frequency calculation module 26. The acceleration sensing module 20 is electrically connected to the signal processing module 22, and the signal acquisition module 24 is electrically connected to the signal processing module 22 and the pedaling frequency calculation module 26. Similarly, the signal processing module 22 is optional and is not intended to limit the disclosure. The measuring device of some other embodiments may not include the signal processing module 22.

As shown in FIG. 5, the acceleration sensing module 20 includes a hall sensing unit 201 and a calculation unit 202 electrically connected to each other. The hall sensing unit 201 is configured to produce a voltage signal V1 according to the variation of the magnetic field. The calculation unit 202 is configured to determine the wheel speed information of the bicycle according to the voltage signal V1, and the calculation unit 202 can produce a forward acceleration signal of the bicycle according to the wheel speed information, as discussed above, the forward acceleration signal is served as the acceleration signal S1. Note that the wheel speed information is associated with the acceleration of the bicycle.

Specifically, the hall sensing unit 201 includes, for example, a magnetic component, a hall sensor, and electronic circuits (not shown). The magnetic component is rotated with the wheel so as to cause the variation of the magnetic field near the hall sensor, such that the hall sensor provided with current can produce a corresponding hall voltage in response to the variation of the magnetic field. During the variation of the magnetic field, the hall voltage output from the hall sensor is in a sine waveform, and the hall voltage of the sine waveform can be transformed into a voltage of pulse form (i.e., a voltage signal V1) by the electronic circuits.

The calculation unit 202 can obtain the wheel speed information (e.g., the wheel speed information WS shown in FIG. 4A) by analyzing and computing the number of the pulses of the voltage signals in a unit time period, and the calculation unit 202 can determine the forward speed of the bicycle. In specific, the calculation unit 202 can determine the forward speed of the bicycle according to the wheel speed by considering the wheel diameter. In practice, except for the case that the bicycle is skidding, the wheel speed information WS can substantially reflect the forward speed of the bicycle.

Then, the calculation unit 202 can further determine and calculate the forward acceleration of the bicycle according to the forward speed (e.g., derived from the wheel speed information WS of FIG. 4A) of the bicycle (e.g., perform a differentiation to the forward speed of the bicycle), then can produce the forward acceleration signal of the bicycle, where the forward acceleration signal is served as the acceleration signal S1. The calculation unit 202 can transmit the acceleration signal S1 to the signal processing module 22 to filter out the measurement error and noise existing in the acceleration signal S1 so as to turn it into the acceleration signal S1′, then the acceleration signal S1′ (i.e., the forward acceleration signal AS of FIG. 4B) is transmitted to the signal acquisition module 24.

Then, the acceleration waveform information PS (e.g., shown in FIG. 3) is acquired from the filtered acceleration signal S1′ by the signal acquisition module 24 according to one or more predetermined parameters. Specifically, the acceleration waveform information PS is obtained by the signal acquisition module 24 filtering out the frequencies of the acceleration signal S1′ that falls out of the acquisition frequency range (e.g., 1 Hz to 3 Hz). In other words, the signal acquisition module 24 (e.g., Band-Pass filter) can filter a part of the filtered acceleration signal S1′ having the frequency falling out the acquisition frequency range to obtain the acceleration waveform information PS shown in FIG. 3, then the signal acquisition module 24 can transmit the acceleration waveform information PS to the pedaling frequency calculation module 26 for waveform reconstruction and pedaling frequency calculation. In practice, the pedaling frequency calculation module 26 can perform the waveform reconstruction using imputation method. The pedaling frequency calculation module 26 can calculate the number of pedaling (i.e., downstroke) during a unit time period to serve as the pedaling frequency data according to the number of the sine waves.

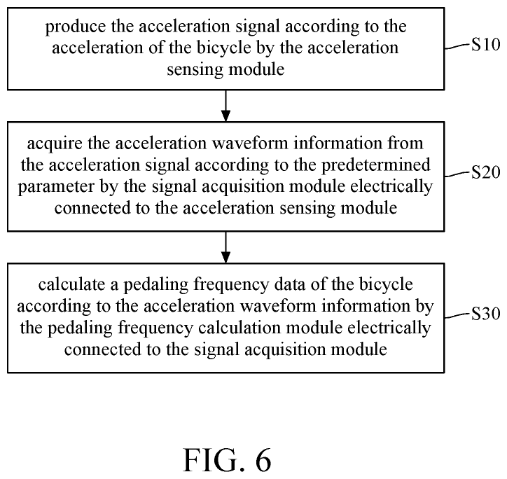

Referring to FIG. 6, there is shown a flow chart of a measuring method according to one embodiment of the disclosure. The measuring method of FIG. 6 is adapted for the measuring device 1 of FIG. 1. The measuring method includes multiple steps S10, S20, and S30. As shown in FIG. step S10 is to produce the acceleration signal S1 according to the acceleration of the bicycle by the acceleration sensing module 10, where the acceleration signal S1 is associated with the acceleration waveform information.

Step S20 is to acquire the acceleration waveform information from the acceleration signal S1 according to the predetermined parameter by the signal acquisition module 14 electrically connected to the acceleration sensing module 10. In one embodiment, the predetermined parameter includes an acquisition frequency range, for example, ranging within 1 Hz to 3 Hz, where the frequency of the acceleration waveform information falls within the acquisition frequency range. Step S30 is to calculate a pedaling frequency data of the bicycle according to the acceleration waveform information by the pedaling frequency calculation module 16 electrically connected to the signal acquisition module 14. In one embodiment, before the signal acquisition module 14 acquires the acceleration waveform information from the acceleration signal S1 according to the predetermined parameter, the measuring method further includes performing the filtering step on the acceleration signal S1 by the signal processing module 12 electrically connected to the acceleration sensing module 10 and the signal acquisition module 14 to output the acceleration signal S1′, where the filtering step includes measurement error filtering and noise filtering.

In one embodiment, the acceleration sensing module 10 is an acceleration sensor of gravity. The acceleration sensing module 10 is disposed on a non-rotatable part of the bicycle frame. The step of producing the acceleration signal S1 according to the acceleration of the bicycle by the acceleration sensing module 10 includes obtaining the forward acceleration signal to serve as the acceleration signal S1 by the acceleration sensor of gravity in response to the acceleration of the bicycle. In practice, the non-rotatable part may be selected from the handlebar, the fork, the seat stay of the bicycle, or another portion of bicycle that does not rotate while the bicycle is moving forward; that is, the acceleration sensor of gravity (i.e., the acceleration sensing module 10) can be mounted on the handlebar, the fork, or the seat stay.

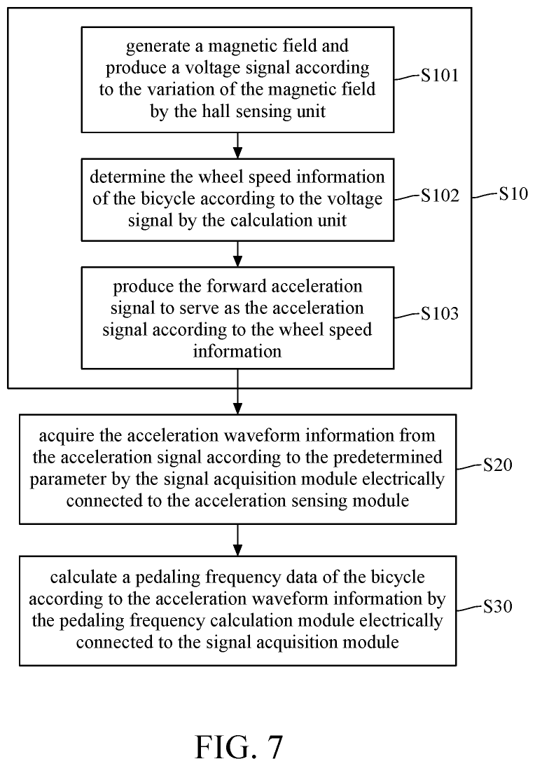

Referring to FIG. 5 and FIG. 7, FIG. 7 is a flow chart of a measuring method according to another embodiment of the disclosure. The measuring method of FIG. 7 is adapted for the measuring device 2 of FIG. 5. Steps S20 and 30 of FIG. 7 are similar to the steps S20 and S30 of FIG. 6, the main difference between the control methods of FIGS. 6 and 7 is in the step S10, thus the following merely introduce step S10 of FIG. 7, and the similar or the same part of the control methods will be omitted hereinafter. In this embodiment, the acceleration of the bicycle is associated with the wheel speed information of the bicycle, and the acceleration sensing module 20 includes the hall sensing unit 201 and the calculation unit 202. The step S10 of producing the acceleration signal S1 according to the acceleration of the bicycle by the acceleration sensing module 20 includes multiple steps S101, 102, and 103. The step 101 is to generate a magnetic field and produce a voltage signal V1 according to the variation of the magnetic field by the hall sensing unit 201. The step S102 is to determine the wheel speed information of the bicycle according to the voltage signal V1 by the calculation unit 202. The step S103 is to produce the forward acceleration signal to serve as the acceleration signal S1 according to the wheel speed information. The previous embodiment has already introduced the specific and detailed implementation of the control methods of FIGS. 6 and 7, thus the following paragraphs will not introduce it repeatedly.

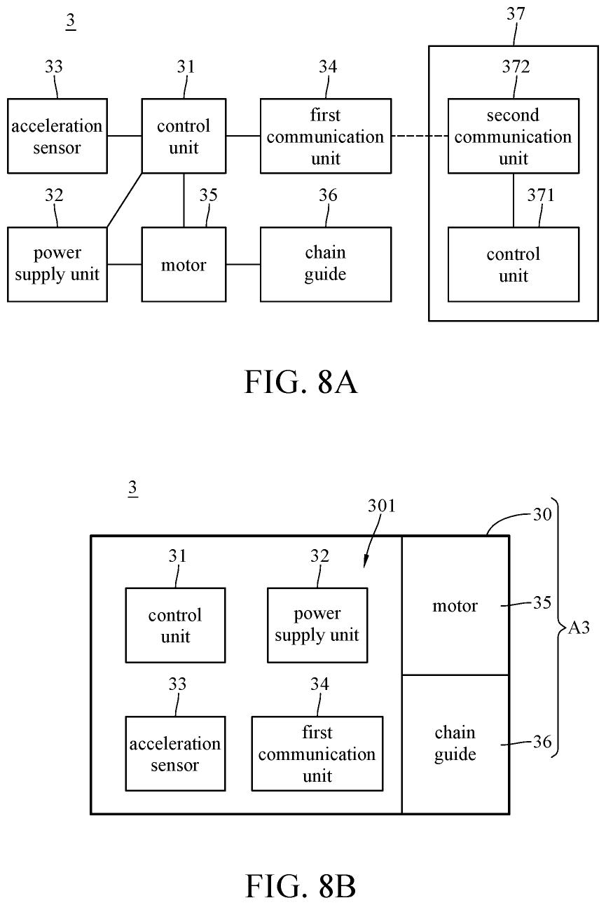

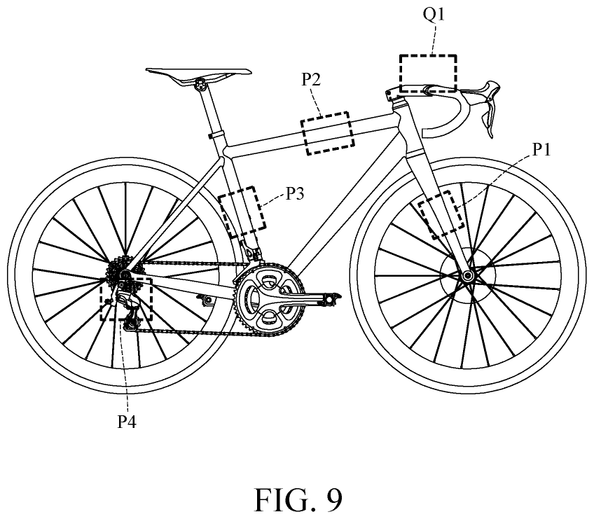

Referring to FIGS. 8A, 8B, and 9, there are shown a block diagram of a measuring device 3 according to one embodiment of the disclosure, a block diagram of the measuring device 3 according to one embodiment of the disclosure, and a schematic view of a bicycle BK according to one embodiment of the disclosure. As shown in FIG. 8B, the measuring device 3 includes a bicycle component A3, a control unit 31, a power supply unit 32, and an acceleration sensor 33. The bicycle component A3 has a casing 30, and the control unit 31, the power supply unit 32, and the acceleration sensor 33 are disposed in an accommodation space 301 of the casing 30. In one embodiment, the bicycle component A3 is disposed on a part of the bicycle BK that is not movable in a circular motion; that is, the bicycle component A3 is disposed on a part of the bicycle BK that is not rotatable in 360 degrees. The non-rotatable part may be selected from a fork (e.g., the position P1), a top tube (e.g., the position P2), a seat tube (e.g., the position P3), or a seat stay (e.g., the position P4) of the bicycle BK as shown in FIG. 9.

As shown in FIG. 8A, the control unit 31 is electrically connected to the power supply unit 32 and the acceleration sensor 33. The power supply unit 32 provides electricity to the control unit 31. The acceleration sensor 33 is configured to produce and transmit an acceleration signal to the control unit 31 to allow the control unit 31 to produce a pedaling frequency signal according to the acceleration signal. As shown in FIGS. 8A and 8B, in practice, the measuring device 3 includes a first communication unit 34 disposed in the accommodation space 301 of the casing 30 of the bicycle component A3 and electrically connected to the control unit 31. In one embodiment, as shown in FIG. 8A, the measuring device 3 may further include a display module 37. The display module 37 may be disposed on a stem (e.g., the position Q1) of the bicycle BK and in signal communication with the control unit 31. The display module 37 is configured to display a pedaling information corresponding to the pedaling frequency signal.

In addition, the display module 37 may include a control unit 371 and a second communication unit 372. The control unit 31 disposed in the bicycle component A3 transmits the pedaling frequency signal to the second communication unit 372 of the display module 37 via the first communication unit 34. Furthermore, after the second communication unit 372 obtains the pedaling frequency signal, the control unit 371 of the display module 37 controls the display interface (not shown) of the display module 37 to display the pedaling information corresponding to the pedaling frequency signal to the rider. In practice, the first communication unit 34 and the second communication unit 372 may be in signal communication with each other via a wireless or wired manner. Note that the display module 37 is optional and is not intended to limit the disclosure; the measuring device of other embodiments may not include the display module 37.

As shown in FIGS. 8A and 8B, in another embodiment, the bicycle component A3 of the measuring device 3 may be a derailleur. As shown in FIG. 8B, the derailleur (the bicycle component A3) may have a motor 35 and a chain guide 36. As shown in FIG. 8A, the motor 35 is electrically connected to the control unit 31 and the power supply unit 32. The power supply unit 32 provides electricity to the motor 35, and the chain guide 36 is connected to the motor 35 so as to be driven by the motor 35. In this embodiment, the control unit 31 drives the motor 35 according to a variation of the pedaling frequency signal to adjust the position of the chain guide 36. In this case, the derailleur (the bicycle component A3) is preferably disposed on the seat tube (e.g., the position P3) or the seat stay (e.g., the position P4) of the bicycle BK, but the disclosure is not limited thereto.

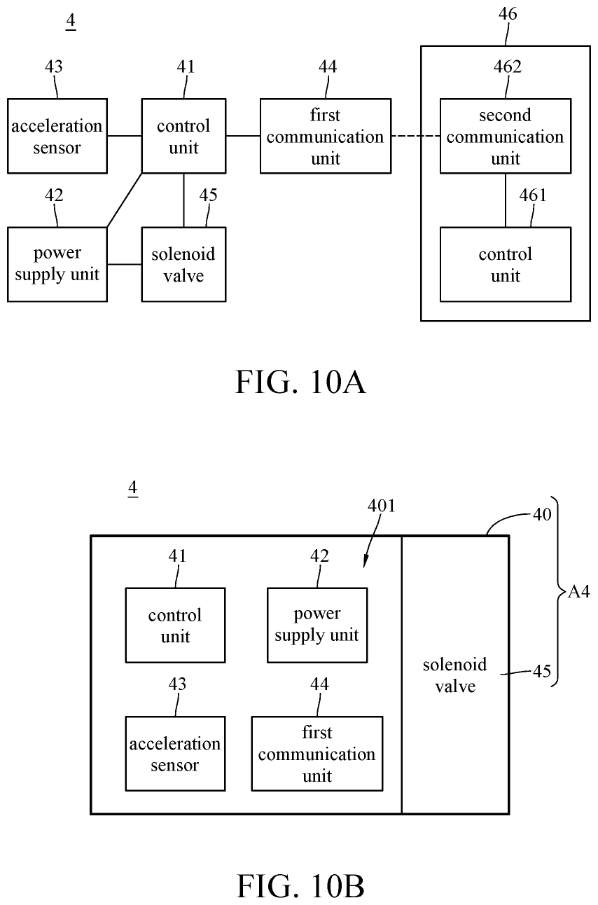

Referring to FIGS. 10A and 10B, there are shown a block diagram of a measuring device 4 according to one embodiment of the disclosure and a block diagram of the measuring device 4 according to another embodiment of the disclosure. In this embodiment of FIGS. 10A and 10B, the measuring device 4 is different from the measuring device 3 of the previous embodiment. The measuring device 4 includes a bicycle component A4, a control unit 41, a power supply unit 42, and an acceleration sensor 43. The bicycle component A4 may be an anti-lock brake device and have a casing 40 and a solenoid valve 45. The control unit 41, the power supply unit 42, the acceleration sensor 43, and the first communication unit 44 of the measuring device 4 are disposed in an accommodation space 401 of the casing 40. The connection, communication and operation among the control unit 41, the power supply unit 42, the acceleration sensor 43 and the first communication unit 44 are similar to that of the control unit 31, the power supply unit 32, the acceleration sensor 33 and the first communication unit 34 of the previously embodiment, thus the later descriptions will not repeatedly introduce them. In this embodiment, as shown in FIG. 10A, the solenoid valve 45 is electrically connected to the control unit 41 and the power supply unit 42. The power supply unit 42 provides electricity to the solenoid valve 45, and the control unit 41 controls the solenoid valve 45 according to the pedaling frequency signal. In this embodiment, the anti-lock brake device (the bicycle component A4) is preferably disposed on the fork (e.g., the position P1) or the top tube (e.g., the position P2) of the bicycle BK, but the disclosure is not limited thereto.

In one embodiment, as shown in FIG. 10A, the measuring device 4 may further include a display module 46. The display module 46 may be disposed on the stem (e.g., the position Q1) of the bicycle BK and in signal communication with the control unit 41. The display module 46 is configured to display the pedaling information corresponding to the pedaling frequency signal. The display module 46 may include a control unit 461 and a second communication unit 462. The control unit 41 disposed in the bicycle component A4 transmits the pedaling frequency signal to the second communication unit 462 of the display module 46 via the first communication unit 44. After the second communication unit 462 obtains the pedaling frequency signal, the control unit 461 of the display module 46 controls the display interface (not shown) of the display module 46 to display the pedaling information corresponding to the pedaling frequency signal to the rider. In practice, the first communication unit 44 and the second communication unit 462 may be in signal communication with each other via a wireless manner or wired manner. Note that the display module 46 is optional and is not intended to limit the disclosure; the measuring device of some other embodiments may not include the display module 46.

As the measuring devices and measuring methods discussed in the above embodiments, the acceleration waveform information obtained by analyzing the acceleration of the bicycle can be used to accurately calculate the pedaling frequency data. As such, the cyclist can timely obtain an accurate pedaling frequency of cycling.

In addition, the measuring device may be integrated in a derailleur or an anti-lock brake device, generally reducing the complexity of the overall design of the bike.

It will be apparent to those skilled in the art that various modifications and variations can be made to the present disclosure. It is intended that the specification and examples be considered as exemplary embodiments only, with a scope of the disclosure being indicated by the following claims and their equivalents.

What is claimed is:

1. A measuring device, comprising:
an acceleration sensing module, configured to produce an acceleration signal according to an acceleration of a bicycle, wherein the acceleration signal is associated with an acceleration waveform information;
a signal acquisition module, electrically connected to the acceleration sensing module, wherein the signal acquisition module acquires the acceleration waveform information from the acceleration signal according to a predetermined parameter; and
a pedaling frequency calculation module, electrically connected to the signal acquisition module, wherein the pedaling frequency calculation module calculates a pedaling frequency data according to the acceleration waveform information.

2. The measuring device according to claim 1, wherein the acceleration sensing module is an acceleration sensor of gravity, the acceleration sensor of gravity is disposed on a non-rotatable part of a frame of the bicycle, the acceleration sensor of gravity is configured to obtain a forward acceleration signal to serve as the acceleration signal according to the acceleration of the bicycle.

3. The measuring device according to claim 2, wherein the non-rotatable part is one of a handlebar, a fork, and a seat stay of the bicycle.

4. The measuring device according to claim 1, wherein the predetermined parameter comprises an acquisition frequency range, and a frequency of the acceleration waveform information falls within the acquisition frequency range.

5. The measuring device according to claim 4, wherein the acquisition frequency range is within a range of 1 Hz to 3 Hz.

6. The measuring device according to claim 1, further comprising a signal processing module electrically connected to the acceleration sensing module and the signal acquisition module, wherein the signal processing module performs a filtering step on the acceleration signal, and the filtering step comprises measurement error filtering and noise filtering.

7. The measuring device according to claim 1, wherein the acceleration of the bicycle is associated with a wheel speed information of the bicycle, and the acceleration sensing module comprises:
a hall sensing unit, configured to produce a voltage signal according to a variation of a magnetic field; and
a calculation unit, electrically connected to the hall sensing unit, wherein the calculation unit determines the wheel speed information according to the voltage signal and produces a forward acceleration signal of the bicycle to serve as the acceleration signal according to the wheel speed information.

8. A measuring method, comprising:
producing an acceleration signal associated with an acceleration waveform information according to an acceleration of a bicycle by an acceleration sensing module;
acquiring the acceleration waveform information from the acceleration signal according to a predetermined parameter by a signal acquisition module electrically connected to the acceleration sensing module; and
calculating a pedaling frequency data of the bicycle according to the acceleration waveform information by a pedaling frequency calculation module electrically connected to the signal acquisition module.

9. The measuring method according to claim 8, wherein the acceleration sensing module is an acceleration sensor of gravity, the acceleration sensor of gravity is disposed on a non-rotatable part of a frame of the bicycle, and the step of producing the acceleration signal according to the acceleration of the bicycle by the acceleration sensing module comprises:
detecting the acceleration of the bicycle to obtain a forward acceleration signal to serve as the acceleration signal by the acceleration sensor of gravity.

10. The measuring method according to claim 9, wherein the non-rotatable part is one of a handlebar, a fork and a seat stay of the bicycle.

11. The measuring method according to claim 8, wherein the predetermined parameter comprises an acquisition frequency range, and a frequency of the acceleration waveform information falls within the acquisition frequency range.

12. The measuring method according to claim 11, wherein the acquisition frequency range is within a range of 1 Hz to 3 Hz.

13. The measuring method according to claim 8, wherein before acquiring the acceleration waveform information from the acceleration signal according to the predetermined parameter by the signal acquisition module, the measuring method further comprises performing a filtering step on the acceleration signal by a signal processing module electrically connected to the acceleration sensing module and the signal acquisition module, wherein the filtering step comprises measurement error filtering and noise filtering.

14. The measuring method according to claim 8, wherein the acceleration of the bicycle is associated with a wheel speed information of the bicycle, and the acceleration sensing module comprises a hall sensing unit and a calculation unit, and the step of producing the acceleration signal according to the acceleration of the bicycle by the acceleration sensing module comprises:
producing a voltage signal according to a variation of a magnetic field by the hall sensing unit; and
determining the wheel speed information according to the voltage signal and producing a forward acceleration signal of the bicycle to serve as the acceleration signal according to the wheel speed information by the calculation unit.

15. A measuring device, comprising:
a bicycle component, configured to be mounted on a part of a bicycle that is not movable in a circular motion;
a control unit, disposed in the bicycle component;
a power supply unit, disposed in the bicycle component and electrically connected to the control unit for providing electricity to the control unit; and
an acceleration sensor, disposed in the bicycle component and electrically connected to the control unit, wherein the acceleration sensor is configured to produce and provide an acceleration signal of the bicycle to the control unit to allow the control unit to calculate and produce a pedaling frequency signal according to the acceleration signal.

16. The measuring device according to claim 15, further comprising:
a display module, wherein the display module is in signal communication with the control unit and configured to display a pedaling information corresponding to the pedaling frequency signal.

17. The measuring device according to claim 16, further comprising:
a first communication unit, disposed in the bicycle component and electrically connected to the control unit, wherein the display module comprises a second communication unit, the control unit is configured to transmit the pedaling frequency signal to the second communication unit via the first communication unit.

18. The measuring device according to claim 15, wherein the bicycle component is a derailleur, the derailleur has a motor and a chain guide, the power supply unit provides electricity to the motor, the chain guide is driven by the motor, and the control unit drives the motor according to a variation of the pedaling frequency signal to adjust a position of the chain guide.

19. The measuring device according to claim 15, wherein the bicycle component is an anti-lock brake device, the anti-lock brake device has a solenoid valve therein, the power supply unit provides electricity to the solenoid valve, and the control unit controls the solenoid valve according to the pedaling frequency signal.

20. The measuring device according to claim 15, wherein the bicycle component is mounted on one of handlebar, a fork, and a seat stay of the bicycle.
